(19) United States
(12) Patent Application Publication
(10) Pub. No.: US 2012/0044224 A1
(43) Pub. Date: Feb. 23, 2012

(54) LIQUID CRYSTAL DISPLAY DEVICE

(75) Inventor: Naoki Michisaka, Osaka-shi (JP)

(73) Assignee: SHARP KABUSHIKI KAISHA, Osaka-shi, Osaka (JP)

(21) Appl. No.: 13/318,379

(22) PCT Filed: May 10, 2010
(86) PCT No.: PCT/JP2010/057891

§ 371 Date: Nov. 1, 2011

(30) Foreign Application Priority Data
May 19, 2009 (JP) 2009-121255

(51) Int. Cl. G09G 3/36; G06F 3/038

(52) U.S. Cl. 345/207; 345/102

(57) ABSTRACT

According to a liquid crystal display device 100, a plurality of light emitting diodes 22 are located in a backlight device 20, and also light receiving sensors 122a through 122d are located at a plurality of sites along an edge portion of a front surface of a liquid crystal panel 10. The control section 200 divides the liquid crystal panel 10 into a plurality of areas A1 through D1, and controls each of the light emitting diodes 22 based on light receiving informational through d1 obtained from the light receiving sensors 122a through 122d. Thus, the brightness of the backlight device 20 is adjusted for each of the areas A1 through D1 independently.

### TECHNICAL FIELD

The present invention relates to a liquid crystal display device, and specifically to a liquid crystal display device including a plurality of light sources located a rear surface of a liquid crystal display section. The present invention claims the benefit of priority based on the legislation of a member country of the Paris Convention or in a country into which the PCT International Application enters the national phase based upon Japanese Patent Application No. 2009-121255 filed on May 19, 2009. The contents of this patent application is incorporated herein by reference.

### BACKGROUND ART

One type of liquid crystal display (LCD) device includes a backlight device located on the side of a rear surface of a liquid crystal display section including a liquid crystal layer. The liquid crystal display section has a structure in which the liquid crystal layer is held between two substrates. Through a manipulation of a voltage applied between the two substrates, the liquid crystal layer is put into a form of shielding light or a form of transmitting light. The backlight device directs light toward the rear surface of the liquid crystal display section. The liquid crystal display section includes a plurality of pixels. When the liquid crystal layer is manipulated while the light which has passed the liquid crystal layer is allowed to pass a color filter, light of a desired color is displayed by each of the pixels.

Regarding such a liquid crystal display device, for example, Japanese Patent Laid-Open Publication No. 2005-121997 (Patent Document 1) discloses a method for adjusting the brightness of the backlight device. According to the disclosure of this publication, a plurality of light sensors are attached at different positions on a peripheral portion on the side of a front surface (on the side of a display plane) of a liquid crystal display device. Illuminance data of external light is captured at every unit time and subjected to a comparative computation. When a numerical value representing the result of the comparative computation exceeds a prescribed value, the illuminance of the peripheral portion of the liquid crystal panel is regarded as being partially changed and therefore the brightness of the backlight device is not adjusted. When the numerical value representing the result of the comparative computation is the prescribed value or less, the illuminance data of the external light is processed by a predetermined operation procedure to calculate the optimum value for controlling the brightness of the backlight device, and thus the brightness of the backlight device is automatically adjusted. According to this method for adjusting the brightness, even when the illuminance of the peripheral portion of the liquid crystal panel is partially changed, the luminance of the backlight device is not changed, and only when the illuminance of the environment in which the liquid crystal panel is installed is uniformly changed, the brightness of the backlight device is automatically adjusted in accordance with the illuminance of the environment.

Japanese Patent Laid-Open Publication No. 2008-209508 (Patent Document 2) describes a device using a light emitting diode as a light source of a backlight device. According to the description of this publication, the backlight device includes a plurality of partial lighting sections which can be controlled independently from each other. The light emission amount of each partial lighting section is controlled in accordance with the amount of environmental light around the device and the luminance distribution of the displayed video included in the video signal. Specifically, when the amount of the environmental light is smaller than a prescribed threshold value, the light emission amount of each partial lighting section, which emits light with a prescribed luminance or higher, is controlled to be decreased. When the amount of the environmental light is larger than the prescribed threshold value, the light emission amount of each partial lighting section, which emits light with the prescribed luminance or higher, is controlled to be increased. It is disclosed that in the case where a plurality of light receiving elements (external light sensors) for sensing the environmental light are provided at, for example, different positions with respect to a light source section from each other, a backlight driving section is controlled by finding an average value of light receiving data from the plurality of light receiving elements.

### CITATION LIST

### Patent Document

Patent Document 1: Japanese Patent Laid-Open Publication No. 2005-121997
Patent Document 2: Japanese Patent Laid-Open Publication No. 2008-209508

### SUMMARY OF THE INVENTION

### Technical Problem

A large liquid crystal display device having a side longer than 1 meter used for an application of TVs or the like has a large screen. Therefore, a part of the screen is likely to be illuminated differently from other parts thereof. For example, even when the liquid crystal display device is located indoors, the screen is illuminated by external light (e.g., by illumination in the room or light coming through the window) and as a result, a part of the screen may become brighter than the other parts. More specifically, there may be cases where a top part of the screen is brighter than a bottom part thereof due to the influence of the illumination in the room, or a part on one side of the screen is brighter than a part on the other side due to the influence of light coming through a window which is located to the one side of the liquid crystal display device. In such cases, a part of the screen of the liquid crystal display device may become difficult to view.

### Solution to the Problem

In one embodiment of the present invention, a liquid crystal display device includes a liquid crystal display section including a plurality of pixels; and a backlight device for directing light from a plurality of light sources toward a rear surface of the liquid crystal display section. Along an edge portion of a front surface of the liquid crystal display section, light receiving sensors are located at a plurality of sites. The liquid crystal display device also includes a control section for dividing the liquid crystal display section into a plurality of areas, and controlling the liquid crystal display section and/or the backlight device based on light receiving information obtained from the light receiving sensors to perform control of adjusting a contrast of each of the areas independently.

According to this liquid crystal display device, for example, the contrast of each of the areas can be appropriately adjusted independently in consideration of the influence of external light. Owing to this, a screen of the liquid crystal display section can be prevented from becoming partially difficult to view by being illuminated by the external light, and the liquid crystal display device can be made easier to view as a whole.

In this case, the plurality of areas into which the liquid crystal display section is divided may be preset by the control section in accordance with the plurality of sites at which the light receiving sensors are located. The contrast of borders between the areas may be controlled such that the contrast is gradually changed between the areas.

In the case where the liquid crystal display section includes a generally rectangular screen, the light receiving sensors may be respectively located on four sides surrounding the generally rectangular screen. The present invention is not limited to this, and in the case where the liquid crystal display section includes the generally rectangular screen, the light receiving sensors may be respectively located at four corners of a peripheral edge portion of the screen. The control section may include a switching section for switching between a mode of performing control of adjusting the contrast of each of the areas independently and a mode of not performing the control of adjusting the contrast. The control section may perform control of adjusting the contrast of each of the areas independently in the case where certain light receiving information is obtained from the light receiving sensors for a predefined time duration. A structure may be adopted in which the rear surface of the liquid crystal display section is divided into areas, different light guide plates are respectively located for the areas, and the light sources direct light toward the rear surface of the liquid crystal display section via the light guide plates. The control section may adjust the contrast of each of the plurality of areas of the screen of the liquid crystal display section independently based on the light receiving information obtained from the light receiving sensors. The control section may adjust the contrast of each of the plurality of areas independently based on a video signal and the light receiving information obtained from the light receiving sensors. The light sources may be light emitting diodes.

### BRIEF DESCRIPTION OF THE DRAWINGS

FIG. 1 is a cross-sectional view of a liquid crystal display device according to one embodiment of the present invention.

FIG. 2 is a block diagram schematically showing a structure of the liquid crystal display device according to the embodiment of the present invention.

FIG. 3 is a cross-sectional view showing a structure of a liquid crystal panel of the liquid crystal display device according to the embodiment of the present invention.

FIG. 4A is a partially enlarged plan view showing locations of light emitting diodes of the liquid crystal display device according to the embodiment of the present invention.

FIG. 4B is a view showing the locations of the light emitting diodes of the liquid crystal display device according to the embodiment of the present invention.

FIG. 5 is a schematic view of the liquid crystal display device according to the embodiment of the present invention.

FIG. 6 is a view showing a circuit configuration of each of pixels of the liquid crystal display device according to the embodiment of the present invention.

FIG. 7 is a block diagram schematically showing a backlight driving circuit of the liquid crystal display device according to the embodiment of the present invention.

FIG. 8 is a block diagram schematically showing a structure of a liquid crystal display device according to another embodiment of the present invention.

FIG. 9 is a control flowchart of a liquid crystal display device according to one embodiment of the present invention.

FIG. 10 is a control flowchart of a liquid crystal display device according to another embodiment of the present invention.

FIG. 11 is a block diagram showing control performed on a liquid crystal display device according to still another embodiment of the present invention.

FIG. 12 is a view conceptually showing contrast adjustment control.

### DESCRIPTION OF EMBODIMENTS

Hereinafter, a liquid crystal display device according to one embodiment of the present invention will be described with reference to the drawings. The figures are provided for easier understanding of the present invention and embodiments thereof. Therefore, the sizes in the figures do not reflect the sizes of actual products embodying the present invention. The figures, even illustrating the same embodiment, do not necessarily match each other. Elements having the same functions bear the same reference characters for the sake of convenience of explanation.

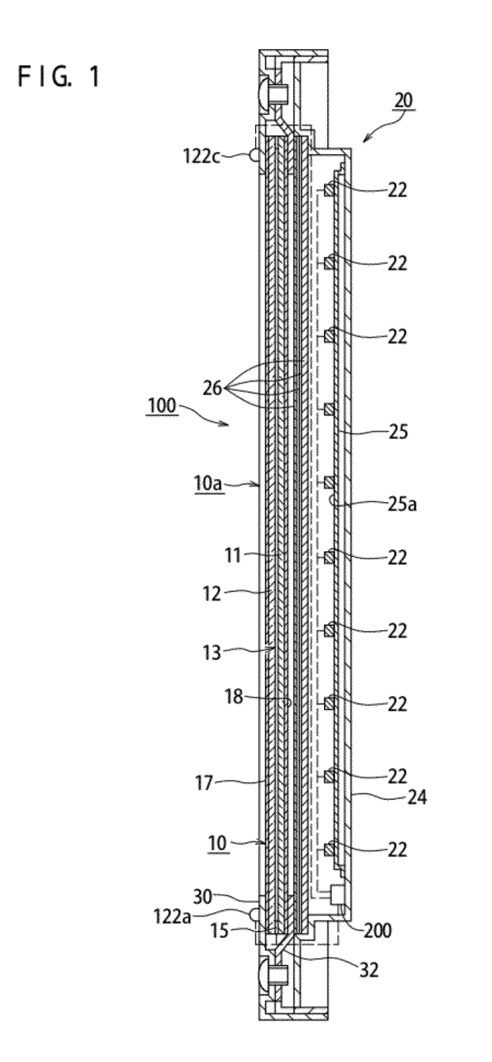

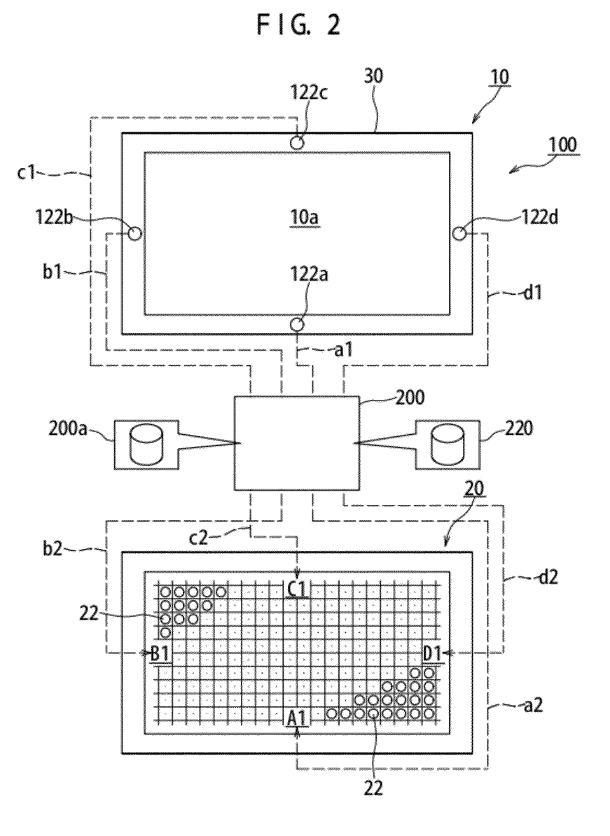

FIG. 1 is a vertical cross-sectional view of a liquid crystal display device 100 according to one embodiment of the present invention. FIG. 2 is a view schematically showing a structure of the liquid crystal display device 100. As shown in FIG. 1, the liquid crystal display device 100 includes a backlight device 20 located on a rear surface of a liquid crystal display section 10. In FIG. 2, the liquid crystal display section 10 and the backlight device 20 are shown separately for the sake of convenience of explanation.

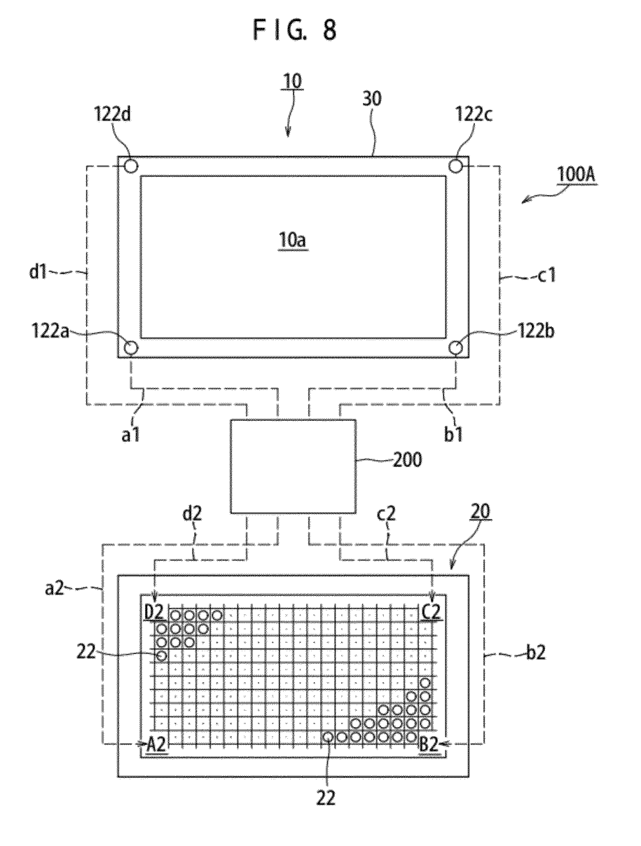

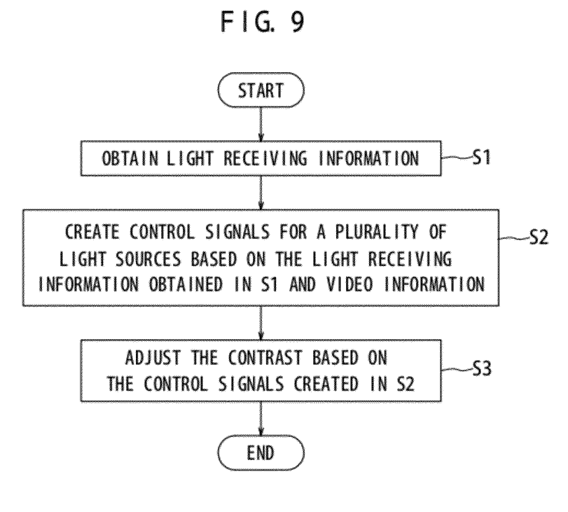

As shown in FIG. 1, the liquid crystal display device 100 includes a liquid crystal panel 10 as the liquid crystal display section and the backlight device 20. The backlight device 20 directs light from a plurality of light sources 22 toward the rear surface of the liquid crystal panel 10. In this embodiment, light emitting diodes 22 (LEDs) are adopted as the light sources 22. The liquid crystal display device 100 includes light receiving sensors 122a through 122d at a plurality of sites along an edge portion of a front surface of the liquid crystal panel 10. As shown in FIG. 8 and FIG. 9, a control section 200 obtains light receiving informational through d1 from the light receiving sensors 122a through 122d (S1). Next, based on the obtained light receiving informational a1 through d1 and a video signal, the control section 200 creates control signals for the plurality of light sources (S2). Then, based on the created control signals, the control section 200 adjusts the brightness of the backlight device 20 (S3). At this point, a screen 10a of the liquid crystal panel 10 is divided into a plurality of areas A1 through D1 (see FIG. 2), and the contrast of each of the areas A1 through D1 is adjusted independently based on the light receiving informational a1 through d1 obtained from the light receiving sensors 122a through 122d.

In the liquid crystal display device 100, even in the case where, for example, a part of the screen 10a is difficult to view by being illuminated by external light, the contrast of each of the areas A1 through D1 is appropriately adjusted independently in consideration of the influence of the external light. Therefore, the screen 10a of the liquid crystal display device 100 can be made easier to view as a whole. Hereinafter, the structure of the liquid crystal display device 100 according to this embodiment will be described in the order of the liquid crystal panel 10 and the backlight device 20. Then, control on the liquid crystal display device 100 will be described.

<Liquid Crystal Panel 10>

In this embodiment, the liquid crystal panel 10 of the liquid crystal display device 100 has a generally rectangular overall shape, and includes a pair of light-transmissive substrates 11 and 12 (in this example, glass substrates) holding a liquid crystal layer 13 therebetween. In this embodiment, among the substrates 11 and 12, the substrate on the rear side (on the side of a rear surface; the backlight device side) is the array substrate 11 (TFT substrate), and the substrate on the front side (on the side of a front surface; the display side) is the color filter substrate 12 (CF substrate).

In this embodiment, as shown in FIG. 1, the array substrate 11 and the color filter substrate 12 are located to face each other. The array substrate 11 and the color filter substrate 12 include a pixel area (area in which pixels are formed) which forms the screen 10a of the liquid crystal display device 100. Between the array substrate 11 and the color filter substrate 12, a seal 15 is provided so as to enclose a peripheral portion of the pixel area (external peripheral edge portion) in a circumferential direction. In a space enclosed by the array substrate 11, the color filter substrate 12 and the seal 15, the liquid crystal layer 13 is formed. In the liquid crystal layer 13, a liquid crystal material containing liquid crystal molecules is enclosed. In such a liquid crystal material (liquid crystal molecules), the alignment direction of the liquid crystal molecules is manipulated by an electric field generated between the array substrate 11 and the color filter substrate 12. Thus, optical characteristics of the liquid crystal layer 13 are changed.

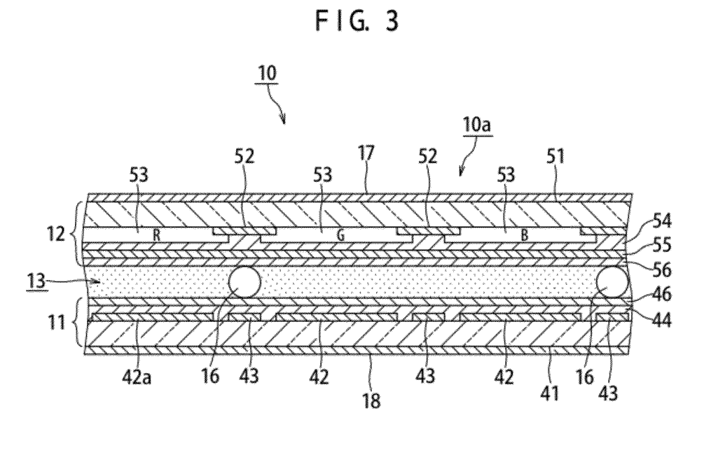

FIG. 3 is a cross-sectional view showing, in enlargement, a part of the liquid crystal panel 10, the part including the pixels formed therein. As shown in FIG. 3, spacers 16 are provided between the array substrate 11 and the color filter substrate 12. The array substrate 11 and the color filter substrate 12 are kept distanced from each other by a prescribed gap by means of the spacers 16. Now, a structure of the array substrate 11 and a structure of the color filter substrate 12 will be described sequentially.

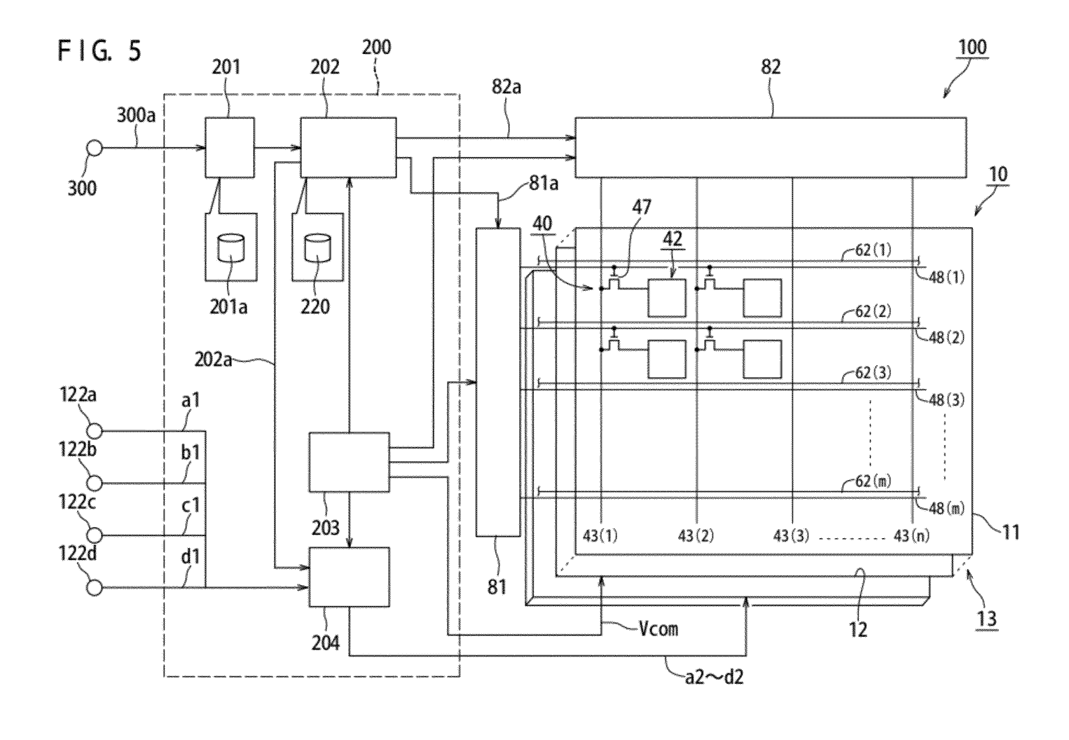

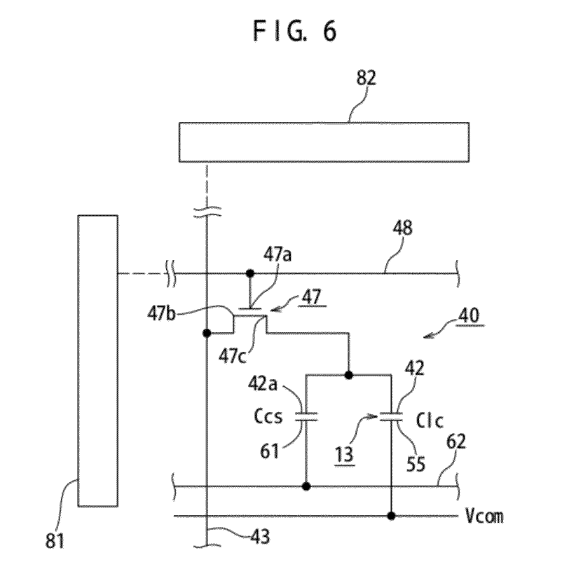

As shown in FIG. 3, the array substrate 11 includes pixel electrodes 42, bus lines 43, a flattening layer 44, and an alignment film 46, and thin film transistors 47 (TFTs; see FIG. 5 and FIG. 6), which are formed on the side of a front surface of a glass substrate 41 (on the liquid crystal layer 13 side). The pixel electrodes 42 are formed of ITO (indium tin oxide), which is a transparent conductive material. These pixel electrodes 42 are each supplied with a voltage in accordance with an image via corresponding bus lines 43 and a corresponding thin film transistor 47 at a prescribed timing. The flattening layer 44 is formed of an insulating material and covers the pixel electrodes 42 and the bus lines 43. On the flattening layer 44, the alignment film 46 formed of polyimide or the like is formed. In FIG. 3, the bus lines 43 are data signal lines. As shown in FIG. 5 and FIG. 6, the array substrate 11 includes the data signal lines 43 and also various other signal lines. The wiring structure of the signal lines and control thereon in the array substrate 11 and the liquid crystal panel 10 will be described later.

The color filter substrate 12 includes a black matrix 52, color filters 53, a flattening layer 54, a counter electrode 55, and an alignment film 56 (horizontal alignment film), which are formed on the side of a rear surface of a glass substrate 51 (on the liquid crystal layer 13 side). The black matrix 52 is formed of a non-light-transmissive material (e.g., metal such as Cr (chromium) or the like), and is provided between the pixels so as to demarcate the pixels. The color filters 53 are filters for adjusting the color of the light. In this embodiment, the color filters 53 are available in three colors of red (R), green (G) and blue (B). As shown in FIG. 3, one pixel electrode 42 of the array substrate 11 faces the color filter 53 of either one of the colors of R, G and B of the color filter substrate 12.

As shown in FIG. 3, the flattening layer 54 of the color filter substrate 12 is formed so as to cover the black matrix 52 and the color filters 53. The counter electrode 55 is formed so as to cover the flattening layer 54. The counter electrode 55 is formed of ITO (indium tin oxide). The alignment film 56 is formed so as to cover the counter electrode 55. The alignment film 56 faces the alignment film 46 of the array substrate 11. A front surface of the alignment film 56 of the color filter substrate 12 has a structure of aligning the liquid crystal molecules. The alignment film 46 of the array substrate 11 and the alignment film 56 of the color filter substrate 12 are formed in order to determine the alignment direction of the liquid crystal molecules in the state where no voltage is applied. The alignment direction provided by the alignment film 56 of the color filter substrate 12 and the alignment direction provided by the alignment film 46 of the array substrate 11 are different by 90° from each other.

As shown in FIG. 1 and FIG. 3, the liquid crystal panel 10 includes polarizing plates 17 and 18 respectively bonded on the side of a front surface of the color filter substrate 12 (glass substrate 51) and on the side of a rear surface of the array substrate 11 (glass substrate 41). In a so-called normally white type liquid crystal display device, the two polarizing plate 17 and 18 are located such that polarization axes thereof are perpendicular to each other. In a so-called normally black type liquid crystal display device, the two polarizing plate 17 and 18 are located such that polarization axes thereof are parallel to each other. In this embodiment, the liquid crystal panel 10 is controlled by the control section 200. The control on the liquid crystal panel 10 will be described later.

As shown in FIG. 1, the liquid crystal panel 10 is supported while being held between a bezel 30 attached on the front side (on the side of the front surface) of the liquid crystal panel 10 and a frame 32 attached on the rear side (on the side of the rear surface) thereof. As shown in FIG. 2, the bezel 30 has an opening at a position corresponding to the screen 10a (pixel area) of the liquid crystal panel 10, and forms an edge portion of the front surface of the liquid crystal panel 10 while being attached to the liquid crystal panel 10. The frame 32 has an opening at a position corresponding to the screen 10a (pixel area) of the liquid crystal panel 10. On the rear side of the liquid crystal panel 10, the backlight device 20 supported by a backlight chassis 24 is attached.

The backlight chassis 24 has a shape of box opened toward the front side (toward the liquid crystal panel 10 side). In the opening of the backlight chassis 24, a plurality of optical sheets 26 are located while being stacked. The backlight chassis 24 is attached on the rear side of the frame 32 for supporting the liquid crystal panel 10 in the state where the light emitting diodes 22 are directed toward the liquid crystal panel 10 mentioned above. The optical sheets 26 are held between a rear surface of the frame 32 and a front surface of the backlight chassis 24. The optical sheets 26 include a plurality of sheets each having a required function (e.g., a diffuser, a diffusion sheet, a lens sheet and a luminance increasing sheet). Light from the backlight device 20 is directed toward the rear surface of the liquid crystal panel 10 via the optical sheets 26.

<Backlight Device 20>

As shown in FIG. 1, the backlight device 20 directs the light from the light sources 22 toward the rear surface of the liquid crystal panel 10. In this embodiment, the backlight device 20 is located on the rear side of the liquid crystal panel 10 (right side in FIG. 1) and illuminates the rear surface of the liquid crystal panel 10. As the light sources of the backlight device 20, a plurality of light emitting diodes 22 (LEDs) are used. On the inner side of the backlight chassis 24, a reflector plate 25 is attached so as to face the rear surface of the liquid crystal panel 10. The light emitting diodes 22 as the light sources are attached to the reflector plate 25 in the state where light emitting sections thereof are directed toward the rear surface of the liquid crystal panel 10. The reflector plate 25 has a minor surface for reflecting light on a surface 25a (reflecting surface) facing the liquid crystal panel 10. The light from the light emitting diodes 22 leaking toward the reflector plate 25 is reflected by the surface 25a toward the rear surface of the liquid crystal panel 10.

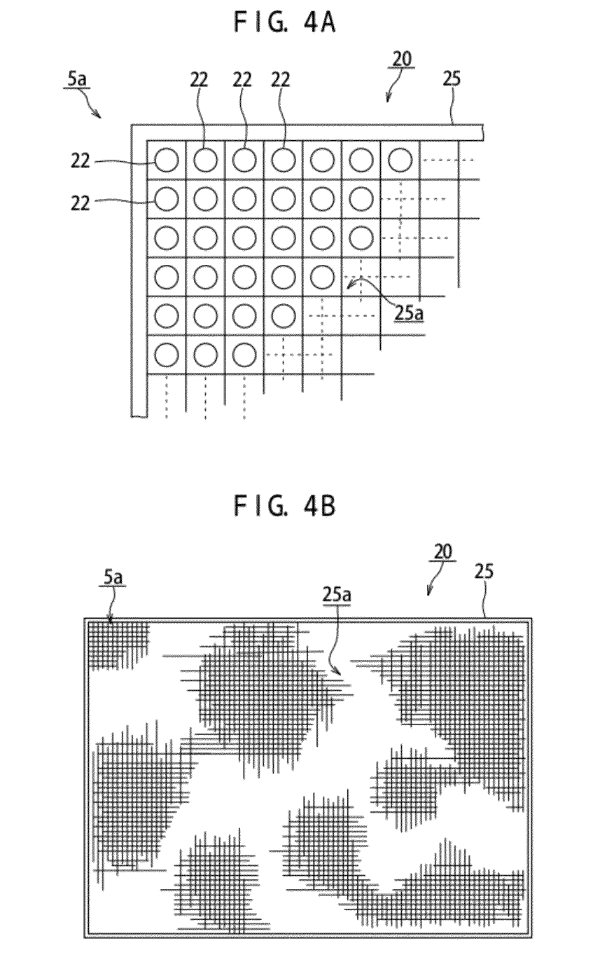

FIGS. 4(a) and 4(b) are each a plan view schematically showing the surface 25a of the reflector plate 25 facing the liquid crystal panel 10. FIG. 4(a) is a plan view showing, in enlargement, a portion represented by arrow 5a in FIG. 4(b). In this embodiment, as shown in FIG. 1 and FIGS. 4(a) and 4(b), the light emitting diodes 22 are located on the surface 25a facing the liquid crystal panel 10 in a generally dispersed state. In this embodiment, as shown in FIGS. 4(a) and 4(b), the light emitting diodes 22 are located as being arranged in a lattice. The light emitting diodes 22 are not limited to being arranged in a lattice as shown in FIGS. 4(a) and 4(b), and may be arranged such that, for example, the light emitting diodes 22 of every other column are positionally shifted (houndstooth check or zigzag arrangement).

As the light from the backlight device 20 of the liquid crystal display device 100, white light may be desirable. In this case, the backlight device 20 in which the light emitting diodes 22 (LEDs) are used may have a structure in which white LEDs for emitting white light are arranged to emit white illumination light or a structure in which a plurality of LEDs of R (red), G (green), blue (B) and the like are arranged and light of these LEDs are mixed to emit white light. The white LEDs may be of a system of obtaining white color by combining a short-wavelength LED chip with RGB fluorescent substances, a system of obtaining white color by combining a blue LED chip with a yellow fluorescent substance, a system of obtaining white color as a mixture of light of LED chips of RGB three colors, a system of obtaining white color as a mixture of light of LED chips of two complementary colors, or the like.

By adjusting the power put to each light emitting diode 22, the brightness is changed. In this case, for example, when the power put to each light emitting diode 22 is increased, the backlight device 20 is made brighter (the luminance is increased); whereas when the power put to each light emitting diode 22 is decreased, the backlight device 20 is made darker (the luminance is decreased). The brightness of the backlight device 20 may be adjusted using, for example, a pulse width modulation method or a PWM (pulse width modulation) system, by controlling the power put to each light emitting diode 22. The backlight device 20 is controlled by the control section 200.

<Control Section 200>

The liquid crystal display device 100 includes the control section 200. The control section 200 is an electronic processing device, and includes computation means including an MPU, a CPU or the like and having a computation function and storage means including a nonvolatile memory or the like. The control section 200 controls the liquid crystal display device 100 by use of a pre-stored program or a mounted electric or electronic circuit, such that the liquid crystal display device 100 exhibits required functions. (Hereinafter, regarding the control section 200, the pre-stored program or the mounted electric or electronic circuit will be referred to as the “program, etc.” when appropriate.) The control on the liquid crystal display device 100 by means of the control section 200 is appropriately set and modified by the above-mentioned program, etc.

Specifically, in the liquid crystal display device 100, a required control signal is sent to the backlight device 20 and the liquid crystal panel 10 in accordance with a video signal by the action of the control section 200. In the liquid crystal panel 10, a controlled voltage is applied to the color filter substrate 12 and the array substrate 11 to manipulate the liquid crystal molecules in the liquid crystal layer 13. The liquid crystal molecules in the liquid crystal layer 13 are manipulated for each pixel independently (in more detail, for each of sub pixels defined by RGB independently), and thus the light from the backlight device 20 is shielded or passed and also the light transmittance is changed. Owing to this, the screen 10a can display, as a whole, a desired image in accordance with the video signal.

Here, the control on the liquid crystal panel 10 will be described first. FIG. 5 schematically shows a structure of the liquid crystal panel 10 of an active matrix type. FIG. 6 shows a circuit configuration provided for each of pixels 40 of the liquid crystal panel 10.

The liquid crystal panel 10 has a structure in which the liquid crystal layer 13 is held between the pair of substrates (the array substrate 11 and the color filter substrate 12) facing each other as described above. In the liquid crystal panel 10, the pixels 40 are arranged in a lattice. Each pixel 40 includes the thin film transistor 47 as a switching device. The thin film transistor 47 is provided in the array substrate 11 as an active matrix substrate. The array substrate 11 includes signal lines provided in a lattice (in a matrix).

In this embodiment, as shown in FIG. 5, a plurality of scanning signal lines 48(1) through (m) and a plurality of data signal lines 43(1) through (n) are provided. The numerical figure in each ( ) is provided in order to distinguish each scanning signal line 48 and each data signal line 43. The scanning signal lines 48 and the data signal lines 43 will be described with the numerical figures in ( ) when necessary. The scanning signal lines 48(l) through (m) are each connected to the thin film transistor 47 of a corresponding pixel 40, and the plurality of data signal lines 43(l) through (n) are each connected to the thin film transistor 47 of a corresponding pixel 40. The numerical figures in ( ) have the same meaning for storage capacitance lines 62 described later. As shown in FIG. 6, the scanning signal lines 48 are each connected to a gate electrode 47a of the corresponding thin film transistor 47. The data signal lines 43 are each connected to a source electrode 47b of the corresponding thin film transistor 47. A drain electrode 47c of the thin film transistor 47 is connected to one of the electrodes which form a storage capacitance Ccs described later, i.e., an electrode 42a, and is further connected to the pixel electrode 42 via the electrode 42a.

As shown in FIG. 6, in each pixel 40, the pixel electrode 42 of the array substrate 11 and the counter electrode 55 of the color filter substrate 12 face each other with the liquid crystal layer 13 being held therebetween. The pixel electrode 42 and the counter electrode 55 form a capacitor Clc for manipulating the liquid crystal layer 13.

The above-mentioned storage capacitance Ccs is formed of one of a pair of electrodes 42a and 61 facing each other with the insulating layer held therebetween. One of the pair of electrodes forming the storage capacitance Ccs, i.e., the electrode 42a is connected to the drain electrode 47c as described above. By contrast, the other electrode 61 forming the storage capacitance Ccs is provided in a corresponding storage capacitance line 62. The storage capacitance Ccs exhibits a function of keeping the voltage applied to the pixel 40 (capacitance Clc for manipulating the liquid crystal layer 13) upon receiving a control signal from the storage capacitance line 62.

As shown in FIG. 5, the scanning signal lines 48(l) through (m) are connected to a gate driver 81. The data signal lines 43(l) through (n) are connected to a source driver 82. The gate driver 81 and the source driver 82 are each connected to the control section 200. The control section 200 is formed by a combination of an IC, an LSI, a CPU, a nonvolatile memory and the like. The control section 200 performs various types of electronic processing in accordance with a preset program and thus exhibits required functions. The driving of the liquid crystal panel 10 is controlled by the control section 200. The control section 200 includes a signal input section 201, a timing controller 202, and a power source 203.

To the signal input section 201, a control signal 300a is input from an external system 300. The control signal 300a includes a signal regarding video to be displayed on the liquid crystal panel 10. In this embodiment, based on the control signal 300a, control signals 81a and 82a are sent from the signal input section 201 to the gate driver 81 and the source driver 82 respectively, via the timing controller 202. The timing controller 202 is a control section for performing control of adjusting the timing of a control signal. In this example, the timing controller 202 adjusts the timing of a control signal for driving the gate driver 81 and the source driver 82 based on the control signal 300a input from the external system 300. The power source 203 supplies an operating power source to each element of the liquid crystal display device 100, and also generates a common electrode voltage (Vcom) for the liquid crystal panel 10 and supplies the common electrode voltage to the counter electrode 55 (see FIG. 5).

In the liquid crystal display device 100, as shown in FIG. 5, the scanning signal lines 48(l) through (m) are located parallel to each other at a prescribed interval. Namely, the scanning signal lines 48(l) through (m) are located in one direction of the lattice. In addition, the scanning signal lines 48(l) through (m) are located parallel to each other in the other direction of the lattice at a prescribed interval so that the scanning signal lines 48 are connected to the corresponding pixels 40 provided in the liquid crystal panel 10 in a lattice. As shown in FIG. 5, the storage capacitance lines 62(l) through (m) are also provided in one direction of the lattice. In addition, the storage capacitance lines 62(l) through (m) are located parallel to each other in the other direction of the lattice at a prescribed interval so that the electrodes 61 of the storage capacitances Ccs of the pixels 40 provided in the liquid crystal panel 10 in the lattice are connected to the corresponding storage capacitance lines 62.

In the liquid crystal display device 100, as shown in FIG. 5 and FIG. 6, scanning signals are sequentially sent to the scanning signal lines 48(l) through (m). In accordance with the scanning signal input to each scanning signal line 48, the thin film transistors 47 of the pixels 40 connected to this scanning signal line 48 are turned ON. Namely, in the liquid crystal panel 10, the thin film transistors 47 of the pixels 40 arranged in each line in one direction of the lattice are turned ON at a time. At the timing at which the thin film transistors 47 are turned ON, data signals (video signals) input to these pixels 40 are sent to the data signal lines 43(l) through (n). Thus, the video signals are written in the pixels 40 arranged in each line in one direction of the lattice are turned ON at a time. At the same timing, control signals are sent to the storage capacitance lines 62. Thus, the voltage applied to the pixels 40 by the action of the storage capacitances Ccs are kept even after the thin film transistors 47 are turned OFF.

Now, control on the backlight device 20 will be described.

In this embodiment, the brightness of the backlight device 20 is also controlled by the control section 200. As shown in FIG. 1 and FIG. 2, in the backlight device 20, the light emitting diodes 22 are each located so as to direct light toward a prescribed area of the rear surface of the liquid crystal panel 10. Therefore, the control section 200 can divide the liquid crystal panel 10 into areas and adjust the brightness of the backlight device 20 for each of the areas independently by controlling each of the light emitting diodes 22. The brightness of the backlight device 20 can be adjusted by controlling the power which is put to each light emitting diode 22. As shown in FIG. 5, the control section 200 includes a backlight driving circuit 204 for controlling the driving of the backlight device 20. The backlight driving circuit 204 sends a control signal to each light emitting diode 22 via the timing controller 202 in accordance with the video signal input to the signal input section 201. In this embodiment, each light emitting diode 22 is controlled along with the control on the liquid crystal panel 10. Owing to this, the brightness of the backlight device 20 can be adjusted in accordance with the video signal. At this point, the control section 200 can divide the liquid crystal panel 10 into areas and adjust the brightness of the backlight device 20 for each of the areas independently. The control on each light emitting diode 22 may be, for example, control on the power put to each light emitting diode 22 performed by a pulse width modulation method or a PWM method.

<Light Receiving Sensors 122a Through 122d>

In this embodiment, as shown in FIG. 2, the light receiving sensors 122a through 122d are located at a plurality of sites along the edge portion of the front surface of the liquid crystal panel 10. As shown in FIG. 2 and FIG. 5, the control section 200 can divide the liquid crystal panel 10 into a plurality of areas A1 through D1 and control the plurality of light emitting diodes 22 based on the light receiving informational a1 through d1 obtained from the light receiving sensors 122a through 122d. In this embodiment, the liquid crystal panel 10 is divided into the plurality of areas A1 through D1 based on the locations of the light receiving sensors 122a through 122d. Based on the light receiving informational a1 through d1 obtained from the light receiving sensors 122a through 122d, the contrast of each of the areas A1 through D1 is adjusted independently.

Specifically, in this embodiment, as shown in FIG. 1 and FIG. 2, the light receiving sensors 122a through 122d are attached to a front surface of the bezel 30 forming the edge portion of the liquid crystal panel 10. As shown in FIG. 2, the liquid crystal panel 10 includes the generally rectangular screen 10a. The light receiving sensors 122a through 122d are respectively located on four sides surrounding the generally rectangular screen 10a of the liquid crystal panel 10. In more detail, in the embodiment shown in FIG. 2, the light receiving sensors 122a through 122d are respectively attached to a central part of the four sides of the bezel 30 surrounding the generally rectangular screen 10a of the liquid crystal panel 10. By locating the light receiving sensors 122a through 122d along the edge portion of the front surface of the liquid crystal panel 10 (for example, as shown in FIG. 2, on the front surface of the bezel 30), the external light illuminating the front surface of the liquid crystal panel 10 can be received appropriately. By locating the light receiving sensors 122a through 122d along the edge portion of the front surface of the liquid crystal panel 10, the screen 10a of the liquid crystal panel 10 can be prevented from being narrowed and the light of the pixels forming the screen 10a can be prevented from being shielded.

As shown in FIG. 2, the light receiving sensors 122a through 122d are connected to the control section 200 by the signal lines. The light receiving sensors 122a through 122d each receive light (mainly, external light other than the light generated from the liquid crystal panel 10). The light receiving informational a1 through d1 based on the light received by the light receiving sensors 122a through 122d is sent to the control section 200 via the signal lines. As the light receiving sensors 122a through 122d, any of various types of light sensors can be used. As the light receiving sensors 122a through 122d, for example, photodiodes, phototransistors, photoresistors, the electric resistance of which is changed in accordance with the intensity of the light incident thereon, or the like may be used. Herein, the “light receiving information” is information sent from each light receiving sensor to the control section 200 based on the received light. Specifically what type of information is the “light receiving information” is varied in accordance with the type of sensor, circuit configuration or the like. Each of the light receiving sensors 122a through 122d sends information in accordance with the intensity of the light, for example, information on the brightness or luminance of the light, to the control section 200 as the light receiving information. Although not shown, the light receiving informational through d1 may be obtained by converting light receiving signals sensed by the sensors by means of I/V (current/voltage) conversion, A/D (analog/digital) conversion or the like when necessary.

<Control on the Liquid Crystal Display Device 100>

As shown in FIG. 2, the control section 200 divides the liquid crystal panel 10 into the plurality of areas A1 through D1 and adjusts the contrast of each of the plurality of areas A1 through D1 independently based on the light receiving informational a1 through d1 obtained from the light receiving sensors 122a through 122d. The control of adjusting the contrast may be, for example, control of adjusting the brightness of the backlight device 20. Alternatively, the control of adjusting the contrast may be control of adjusting the brightness of the liquid crystal panel 10. The contrast may be adjusted by controlling both of the backlight device 20 and the liquid crystal panel 10. It is preferable that the plurality of areas A1 through D1 are preset in accordance with, for example, the plurality of sites at which the light receiving sensors 122a through 122d are located as shown in FIG. 2.

In this embodiment, the control of adjusting the contrast is control of adjusting the brightness of the backlight device 20. The backlight device 20 includes the plurality of light emitting diodes 22 as the light sources. For adjusting the brightness of the backlight device 20, it is preferable that the brightness of the light emitting diodes 22 is adjusted for each of the areas A1 through D1 independently. The brightness of each light emitting diode 22 can be adjusted by controlling the power put to the light emitting diode 22. Specifically, in this embodiment, as shown in FIGS. 4(a) and 4(b), the light emitting diodes 22 are arranged in a lattice on the surface 25a facing the liquid crystal panel 10. As shown in FIG. 2, the control section 200 divides the liquid crystal panel 10 into the plurality of areas A1 through D1 by the setting provided by the program, etc. The light emitting diodes 22 are controlled based on the light receiving information obtained from the light receiving sensors 122a through 122d, and the brightness of the backlight device 20 is adjusted for each of the areas A1 through D1 independently.

The light receiving sensors 122a through 122d receive external light illuminating the screen 10a of the liquid crystal panel 10. In the case where the liquid crystal display device 100 is illuminated by the external light (light other than the light generated from the liquid crystal display device 100) and thus a part of the screen 10a is made brighter than the other parts, the light receiving sensors 122a through 122d sense different levels of brightness from each other. The light emitting diodes 22 are controlled based on the light receiving informational a1 through d1 obtained from the light receiving sensors 122a through 122d, and the brightness of the backlight device 20 is adjusted for each of the areas A1 through D1 independently. Therefore, the problem that the screen 10a is made difficult to view when the screen 10a is illuminated by the external light and thus a part thereof is made brighter than the other parts can be alleviated.

In this case, it is preferable that, for example, the control section 200 appropriately adjusts the brightness of the backlight device 20 for each of the areas independently in accordance with a difference in the light receiving information sensed by the light receiving sensors 122a through 122d, so as to prevent the liquid crystal panel 10 from becoming partially difficult to view. It is also preferable that, for example, as shown in FIG. 2, the liquid crystal panel 10 is divided into a plurality of areas A1 through D1 in correspondence with the sites at which the light receiving sensors 122a through 122d are located. It is preferable that the light emitting diodes 22 for illuminating each of the areas A1 through D1 are controlled independently based on the light receiving informational a1 through d1 obtained by the light receiving sensors 122a through 122d. Such control is preferably realized by the program, etc. set in the control section 200.

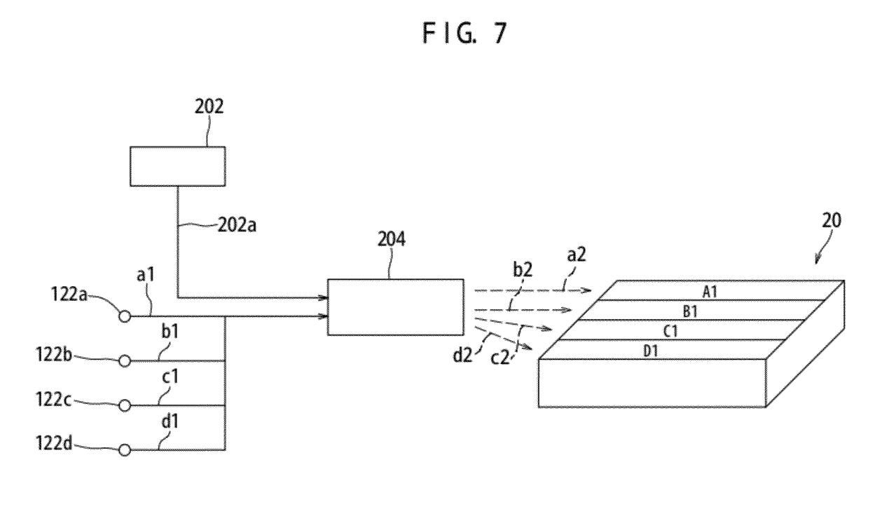

FIG. 7 schematically shows the backlight driving circuit 204. In this case, as shown in FIG. 7, the backlight driving circuit 204 can, for example, send a control signal to each light emitting diode 22 based on the light receiving informational a1 through d1 obtained from the light receiving sensors 122a through 122d in addition to a control signal 202a sent from the timing controller 202. To the backlight driving circuit 204, the control signal 202a sent from the timing controller 202 and the light receiving informational a1 through d1 obtained from the light receiving sensors 122a through 122d are input. The backlight driving circuit 204 creates control signals a2 through d2 for controlling the areas A1 through D1 predefined in the backlight device 20 based on the input control signal 202a and light receiving informational a1 through d1. Based on the control signals a2 through d2, the light emitting diodes 22 in the areas A1 through D1 of the backlight device 20 are controlled.

Owing to this, in the case where, for example, the top part of the screen 10a is brighter than the bottom part due to the influence of the illumination in the room, it is sensed that the top part of the liquid crystal panel 10 is brighter than the bottom part by the light receiving sensors 122a through 122d shown in FIG. 2. In this case, it is preferable that the brightness of the backlight device 20 is adjusted for the top and bottom parts set in the liquid crystal panel 10 based on the light receiving informational a1 through d1 obtained from the light receiving sensors 122a through 122d. Thus, the contrast of each of the areas can be adjusted independently in accordance with the brightness difference between the top and bottom parts of the liquid crystal panel 10.

There may be a case where, for example, a left part of the liquid crystal display device 100 is brighter than a right part thereof due to the influence of light coming through a window (not shown) located to the left of the liquid crystal display device 100 as seen from the observer. In this case, it is sensed that the left part of the liquid crystal panel 10 is brighter than the right part by the light receiving sensors 122a through 122d shown in FIG. 2. In this case, it is preferable that the brightness of the backlight device 20 is adjusted for the left and right parts set in the liquid crystal panel 10 based on the light receiving informational a1 through d1 obtained from the light receiving sensors 122a through 122d. Thus, the contrast of each of the areas can be adjusted independently in accordance with the brightness difference between the left and right parts of the liquid crystal panel 10.

In this case, the control section 200 may be structured to adjust the contrast of each of the areas A1 through D1 independently in accordance with the brightness of the sites at which the light receiving sensors 122a through 122d are located based on the light receiving informational a1 through d1 obtained from the light receiving sensors 122a through 122d. For example, it is preferable that the contrast is appropriately adjusted in accordance with the degree (e.g., the degree of brightness) of the light receiving informational a1 through d1 obtained from the light receiving sensors 122a through 122d. Regarding how the contrast is to be adjusted based on the light receiving informational a1 through d1 obtained from the light receiving sensors 122a through 122d, it is preferable that, for example, the ease of viewing the screen 10a is evaluated by a test performed in advance. It is preferable that based on the test results, the control on the contrast based on the light receiving informational a1 through d1 obtained from the light receiving sensors 122a through 122d is appropriately set by the program, etc.

<Control of Adjusting the Contrast>

The control section 200 may be structured to be capable of adjusting the contrast of the screen 10a of the liquid crystal panel 10 for each of the plurality of areas A1 through D1 independently based on the video signal and the light receiving informational a1 through d1 obtained from the light receiving sensors 122a through 122d. In this case, it is preferable that the control section 200 adjusts the contrast such that the contrast is strengthened at a bright site of the liquid crystal panel 10 and is weakened at a dark site of the liquid crystal panel 10 based on the light receiving informational a1 through d1 obtained from the light receiving sensors 122a through 122d. In this case, it is preferable that the brightness of the liquid crystal panel 10 is determined based on the light receiving informational a1 through d1 obtained from the light receiving sensors 122a through 122d as a result of a comparison with a certain threshold value provided for the light receiving informational a1 through d1 obtained from the light receiving sensors 122a through 122d.

For example, in the case where a top part of the screen 10a is brighter than a bottom part thereof due to the influence of the illumination in the room, it is sensed that the top part of the liquid crystal panel 10 is brighter than the bottom part by the light receiving sensors 122a and 122c shown in FIG. 2. In this case, the control may be set such that the contrast of the backlight device 20 is adjusted in the top and bottom areas A1 and C1 set in the liquid crystal panel 10 in accordance with the brightness difference between the top and bottom parts of the liquid crystal panel 10. In this manner, the contrast of each of the areas A1 through D1 set in the liquid crystal panel 10 can be adjusted independently based on the light receiving information a1 through d1 obtained from the light receiving sensors 122a through 122d. Therefore, the liquid crystal panel 10 can be prevented from becoming partially difficult to view as a result of being illuminated by the external light, and thus the screen 10a can be made easier to view as a whole. For example, it is preferable that the contrast of a prescribed area of the screen 10a is strengthened or weakened based on the light receiving informational a1 through d1 obtained from the light receiving sensors 122a through 122d.

Regarding how the contrast of the screen 10a is to be adjusted based on the light receiving informational a1 through d1 obtained from the light receiving sensors 122a through 122d, it is preferable that, for example, the ease of viewing the screen 10a is evaluated by a test performed in advance. It is preferable that based on the test results, the control on the brightness of the backlight device 20 based on the light receiving informational a1 through d1 obtained from the light receiving sensors 122a through 122d is appropriately set by the program, etc. Regarding the adjustment of the contrast, instead of only the backlight device 20 being controlled, the control on the liquid crystal panel 10 may be associated with the control on the backlight device 20 for each of the areas A1 through D1, so that the contrast of the screen 10a is adjusted for each of the areas A1 through D1 independently. Owing to this, the contrast of the screen 10a can be appropriately adjusted for each of the areas A1 through D1 independently in consideration of the influence of the external light. Thus, the screen 10a of the liquid crystal panel 10 can be prevented from becoming partially difficult to view as a result of being illuminated by the external light, and the screen 10a can be controlled as a whole to display video more appropriately in a manner desired by a user.

Some liquid crystal display devices include a contrast adjustment controller (e.g., a contrast enhancer) for strengthening or weakening the contrast based on the setting by a user or the video signal. The contrast enhancer performs processing of adjusting the contrast of the output video in accordance with the luminance distribution of the input video information.

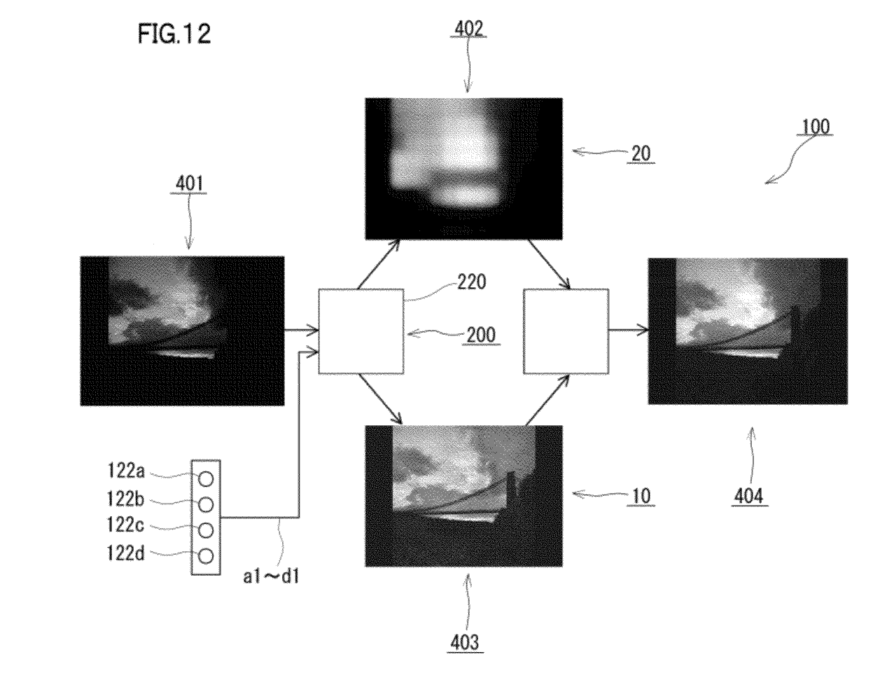

FIG. 12 conceptually shows contrast adjustment control. In this example, when an image including a bright part and a dark part (e.g., an image of a landscape having a bright part and a dark part such as, for example, a glow of dawn and a sunset glow) is displayed on a part of the screen, the contrast is strengthened.

In this case, video information (input image 401) is input to the control section 200. In this embodiment, the control section 200 adjusts the contrast of the screen 10a for each of the areas independently based on the video information (input image 401) (area active processing 220; see FIG. 5). At this point, the control section 200 generates control information for controlling the backlight device 20 for each of the areas of the screen 10a independently (LED control data 402) and control information for controlling each of the pixels in the liquid crystal panel 10 (LCD control data 403). For strengthening the contrast, it is preferable that the LED control data 402 and the LCD control data 403 are generated such that, for example, a bright part of the input image 401 becomes still brighter and a dark part of the input image 401 becomes still darker. In an example, it is preferable that a certain threshold value is provided for luminance information of the input image 401, and for a pixel having a luminance higher than the threshold value, such a high luminance is multiplied by a predefined coefficient to increase the luminance; whereas for a pixel having a luminance lower than the threshold value, such a low luminance is multiplied by the predefined coefficient to decrease the luminance. Owing to this, the generated LED control data 402 and LCD control data 403 each have the contrast strengthened.

In FIG. 12, the LED control data 402 represents an image of the backlight device 20 controlled by the LED control data 402 processed as described above. In this case, the backlight device 20 is bright in a part where the input image 401 is bright and is dark in a part where the input image 401 is dark. In FIG. 12, the LCD control data 403 represents an image of the liquid crystal panel 10 controlled by the LCD control data 403 processed as described above. In this case, the pixels of the liquid crystal panel 10 are controlled such that the liquid crystal panel 10 is bright in a part where the input image 401 is bright and is dark in a part where the input image 401 is dark. Owing to this, an output image 404 from the liquid crystal display device 100 has the contrast strengthened as compared with the input image 401 as shown in FIG. 12.

The liquid crystal display device 100 in this embodiment may perform, in addition to the above processing, the processing of adjusting the contrast of each of the areas A1 through D1 of the screen 10a independently based on the light receiving informational a1 through d1 obtained from the light receiving sensors 122a through 122d described above (see FIG. 2). Owing to this, in addition to the contrast adjustment control being performed as described above, the contrast of the screen 10a can be appropriately controlled for each of the areas independently in consideration of the case where a part of the screen 10a is brighter than the other parts due to the influence of the illumination in the room. As described above, as the control of adjusting the contrast, control of adjusting the contrast by adjusting the brightness of each pixel of the liquid crystal panel 10 may be performed.

As described above, the liquid crystal display device 100 includes the plurality of light emitting diodes 22 in the backlight device 20 and also includes the light receiving sensors 122a through 122d at a plurality of sites along the edge portion of the front surface of the liquid crystal panel 10. The control section 200 divides the liquid crystal panel 10 into the plurality of areas A1 through D1, and controls the contrast of each of the areas A1 through D1 independently based on the light receiving informational a1 through d1 obtained from the light receiving sensors 122a through 122d.

As shown in FIG. 8 and FIG. 9, the backlight driving circuit 204 obtains the light receiving informational a1 through d1 from the light receiving sensors 122a through 122d located at a plurality of sites along the edge portion of the front surface of the liquid crystal panel 10 (first step (S1)). Next, based on the light receiving informational a1 through d1 obtained in the first step (S1), the contrast of each of the areas A1 through D1 is adjusted independently (second step (S2, S3)). For example, in the liquid crystal display device 100, the contrast is controlled based on the light receiving informational a1 through d1 obtained from the light receiving sensors 122a through 122d in addition to based on the control signal 202a sent from the timing controller 202. Therefore, for example, the brightness of the backlight device 20 can be appropriately adjusted for each of the areas A1 through D1 independently in consideration of the influence of the external light. Thus, the screen 10a of the liquid crystal panel 10 can be prevented from becoming partially difficult to view by being illuminated by the external light, and the screen 10a can be made easier to view as a whole.

In this case, it is preferable that the plurality of divided areas A1 through D1 into which the liquid crystal panel 10 is divided is preset in accordance with the plurality of sites at which the light receiving sensors 122a through 122d are located, by means of the control section 200 by use of the program, etc. Owing to this, the liquid crystal panel 10 can be appropriately divided into the plurality of areas A1 through D1 in accordance with the locations of the light receiving sensors 122a through 122d, and thus the backlight device 20 can be appropriately controlled. For example, in the above-described embodiment, in the liquid crystal panel 10 including the generally rectangular screen 10a, the light receiving sensors 122a through 122d are respectively located on four sides surrounding the generally rectangular screen 10a along the edge portion of the front surface of the liquid crystal panel 10. In this case, it is preferable that as shown in FIG. 2, the areas A1 through D1 into which the liquid crystal panel 10 is divided are respectively set in the bottom, left, top and right parts of the liquid crystal panel 10 in accordance with the locations of the light receiving sensors 122a through 122d on the four sides, i.e., the bottom, left, top and right sides.

Regarding the above-described control method, in the second step (S2), the contrast of borders between the areas A1 through D1 may be controlled such that the contrast is gradually changed between the areas A1 through D1. Owing to this, an event that the contrast is conspicuously changed at the borders between the areas A1 through D1 set in the liquid crystal panel 10 can be prevented. For example, it is preferable that the brightness of the backlight device 20 is gradually changed between the areas A1 through D1.

In this case, it is preferable, for example, that the centers of the areas A1 through D1 are set in the vicinity of the light receiving sensors 122a through 122d, respectively. It is preferable that the light emitting diodes 22 are controlled such that the brightness of the backlight device 20 is gradually changed between the areas A1 through D1, for example, such that the brightness of the backlight device 20 is gradually changed in accordance with the distance from each of the areas A1 through D1.

So far, one embodiment of the present invention has been described. The present invention is not limited to the above-described embodiment.

For example, the locations of the light receiving sensors 122a through 122d on the liquid crystal panel 10 are not limited to those described above. In the above-described embodiment, as shown in FIG. 2, on the liquid crystal panel 10 including the generally rectangular screen 10a, the light receiving sensors 122a through 122d are respectively located on four sides surrounding the generally rectangular screen 10a along the edge portion of the front surface of the liquid crystal panel 10. By contrast, FIG. 8 shows a liquid crystal display device 100A according to another embodiment of the present invention. As shown in FIG. 8, the light receiving sensors 122a through 122d may be located at four corners of the peripheral edge portion of the generally rectangular screen 10a. The four corners of the peripheral edge portion of the generally rectangular screen 10a each have a diagonal length greater than the width of the four sides surrounding the generally rectangular screen 10a. Therefore, it is easier to securely keep an area size sufficiently large to locate the light receiving sensors 122a through 122d.

In this case, for example, as shown in FIG. 8, it is preferable that a plurality of areas A2 through D2 into which the liquid crystal panel 10 is divided are set so as to center around the four corners of the screen 10a, in correspondence with the locations of the light emitting sensors 122a through 122d. It is also preferable that the brightness of the backlight device 20 is controlled each of the areas A2 through D2 independently based on the light receiving informational a1 through d1 obtained by the light receiving sensors 122a through 122d. As understood from this, the locations of the light receiving sensors 122a through 122d may be variously altered. Although not shown, the number of the light receiving sensors 122a through 122d located along the edge portion of the front surface of the liquid crystal panel 10 may be increased or decreased, or may be appropriately increased in accordance with the size of the liquid crystal panel 10.

For example, a plurality of light receiving sensors may be located at an appropriate interval around the generally rectangular screen 10a (on the four sides surrounding the screen 10a (see FIG. 2), at the four corners of the peripheral edge portion of the screen 10a (see FIG. 8), etc.). In this case, as the number of the light receiving sensors is increased, the screen 10a can be divided into areas in a finer manner. Therefore, finer control on the brightness adjustment and on the contrast is made possible. However, when the number of the light receiving sensors is increased, the production cost of the liquid crystal display device 100 is raised. Hence, it is preferable that the number and the locations of the light receiving sensors are determined such that the backlight device 20 is appropriately controlled to prevent the liquid crystal panel 10 from becoming partially difficult to view, and also in consideration of the production cost or the like.

In the above-described embodiment, the control section 200 controls the contrast and also performs other controls on the liquid crystal display device 100. The present invention is not limited to such an embodiment, and the other controls on the liquid crystal display device 100 and the control on the contrast may be performed by different control circuits from each other. The above-described control of adjusting the brightness or the contrast of each of the areas independently may be set to be performed when necessary. For example, as shown in FIG. 2, the control section 200 may include a switching section 200a for switching between a mode of performing the above-described control of adjusting the contrast and a mode of not performing the above-described control of adjusting the contrast.

For example, when a person walks in front of the liquid crystal display device, a part of the light receiving sensors temporarily senses darkness caused by the shadow of the person. If the above-described control of adjusting the brightness is performed in such a case, an unpleasant event that, for example, the image flickers may occur. Therefore, the control section 200 may be set to perform the above-described brightness adjustment control when certain light receiving information is obtained for a predefined time duration.

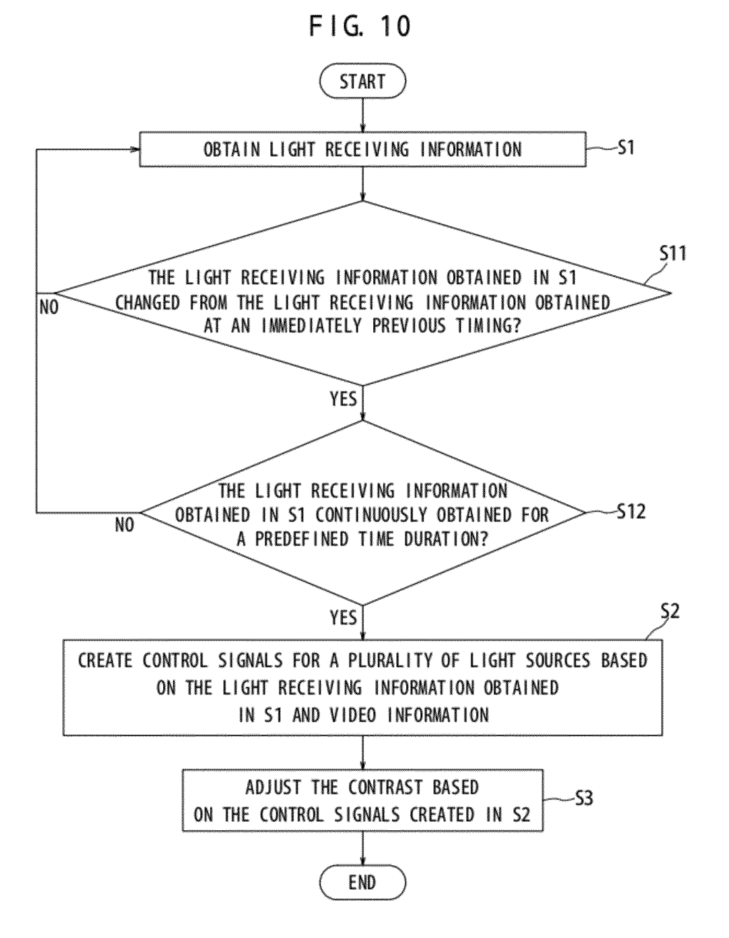

In this case, as shown in FIG. 10, the control section 200 obtains light receiving information from the light receiving sensors 122a through 122d (step S1), and determines “whether or not the light receiving information obtained in step S1 has been changed from the light receiving information obtained at an immediately previous timing” (step S11). When it is determined in such determination processing S11 that the light receiving information obtained in step S1 has not been changed from the light receiving information obtained at the immediately previous timing (NO), the processing of step S1 is repeated. When it is determined in the determination processing S11 that the light receiving information obtained in step S1 has been changed from the light receiving information obtained at the immediately previous timing (YES), determination processing S12 is performed. In the determination processing S12, it is determined “whether or not the light receiving information obtained in step S1 was obtained continuously for a predefined time duration”. The “predefined time duration” is used for the purpose of preventing the above-described brightness adjustment control from being performed in an event that a part of the light receiving sensors temporarily senses darkness. It is preferable to set, as the “predefined time duration”, an appropriate time duration suitable for this purpose.

When it is determined in the determination processing S12 that the light receiving information obtained in step S1 was not obtained continuously for the predefined time duration (NO), the processing of step S1 is repeated. When it is determined in the determination processing S12 that the light receiving information obtained in step S1 was obtained continuously for the predefined time duration (YES), the processing of step S2 and the processing of step S3 are performed sequentially. In the processing of step S2, control signals for a plurality of light sources are created based on the light receiving information obtained in step S1 and a video signal. In the processing of step S3, the brightness of the backlight device 20 is adjusted based on the control signals created in step S2.

According to such control, even when a person walks in front of the liquid crystal display device and a part of the light receiving sensors temporarily senses darkness caused by the shadow of the person, an event that the above-described brightness adjustment control is performed and thus the image flickers can be suppressed.

So far, various types of liquid crystal display device 100 according to various embodiments of the present invention have been described. The present invention is not limited to these embodiments either, and may be variously altered.

For example, the above-described structure of the liquid crystal panel is merely an example. Various proposals have been made by the prior art regarding the structure of the liquid crystal panel, and there is no specific limitation on the structure of the liquid crystal panel according to the present invention. The type of, and the manner of locating, the light emitting diodes as the light sources are not limited to those in the above-described embodiments. In the above-described embodiments, as an example of backlight device, a so-called full-array type LED backlight device in which the light emitting diodes face the rear surface of the liquid crystal panel is shown. The backlight device is not limited to such a type and may be of any type which directs the light from a plurality of light emitting diodes toward the rear surface of the liquid crystal display section. Therefore, for example, the backlight device may direct the light from the light emitting diodes toward the rear surface of the liquid crystal display section via a light guide plate. In this case, for example, the structure may be such that the rear surface of the liquid crystal panel is divided into areas, different light guide plates are located respectively for the areas, and the light guide plates are each controlled independently so as to adjust the brightness of the backlight device for each of the areas independently.

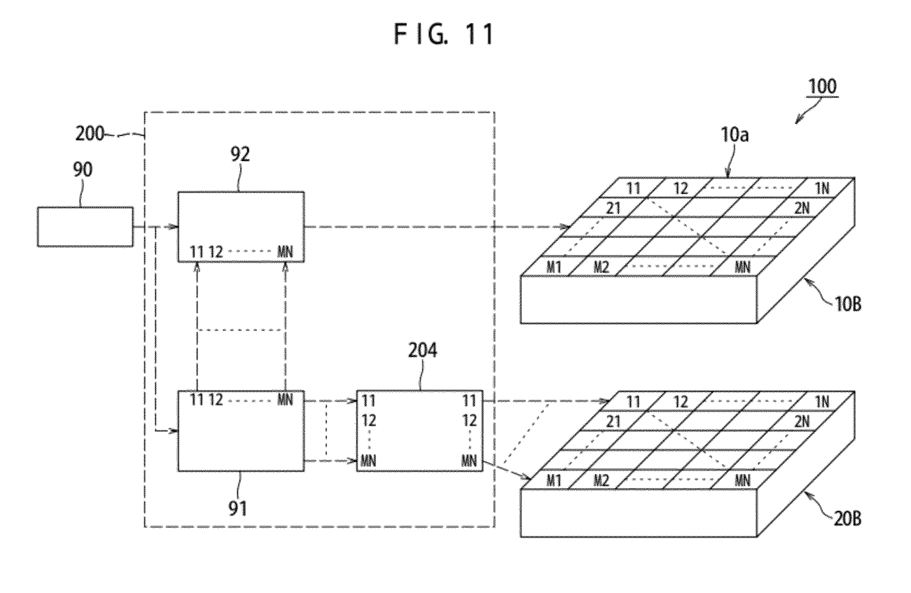

FIG. 11 is a block diagram illustrating a liquid crystal display device 100B in such a modification.

In this embodiment, a backlight device 20B is divided into M rows×N columns of divided illumination areas (11, 12, 13, . . . MN) arranged in a lattice (in a matrix; in the example of the figure, M×N). In this embodiment, the backlight device 20B is lit up, lit out, adjusted in luminance or the like for each of the divided illumination areas (11, 12, 13, . . . MN) independently. Namely, different light guide plates are respectively located for the areas, and the light guide plates are each controlled independently so as to adjust the brightness of the backlight device for each of the areas independently.

The screen 10a of a liquid crystal panel 10B is divided into areas in correspondence with the divided illumination areas (11, 12, 13, . . . MN) of the backlight device 20B. The areas of the screen 10a are also represented with 11, 12, 13, . . . MN in correspondence with the divided illumination areas (11, 12, 13, . . . MN) of the backlight device 20B for the sake of convenience.

As shown in FIG. 11, the liquid crystal display device 100B is controlled by the control section 200. In this case, as shown in FIG. 11, the control section 200 includes a maximum gray scale level detection circuit 91 and a gray scale conversion circuit 92. The maximum gray scale level detection circuit 91 detects the maximum gray scale level of each of the above-described divided areas (11, 12, 13, . . . MN) independently. The gray scale conversion circuit 92 converts a display image signal 90 in accordance with the maximum gray scale level in one frame of each of the divided areas (11, 12, 13, . . . MN). Then, the gray scale conversion circuit 92 creates an input image signal to be input to the liquid crystal panel 10B for each of the divided display areas.

In this case, it is preferable that as shown in FIG. 2 or FIG. 8, the control section 200 divides the screen 10a into areas A1 through D1 based on the light receiving informational through d1 obtained by the light receiving sensors 122a through 122d and optimizes the control on the backlight device 20 for each of the areas A 1 through D1 independently.

As shown in FIG. 5, for example, the control section 200 of the above-described liquid crystal display device 100 may be structured to include a receiving section 201a for receiving TV broadcast in the signal input section 201 so that an image based on the TV broadcast received by the receiving section 201a is displayed. The control section 200 may control the liquid crystal display section 10 and the backlight device 20 such that an image based on the TV broadcast received by the receiving section 201a is displayed by the liquid crystal display device 100. As understood from this, the liquid crystal display device 100 can be a part of a TV receiver. The video information to be input to the signal input section 201 is not limited to an image based on the TV broadcast, and may be an image sent from any of various video devices.

### DESCRIPTION OF REFERENCE CHARACTERS

10, 10B Liquid crystal panel (liquid crystal display section)
10a Screen
11 Array substrate
12 Color filter substrate
13 Liquid crystal layer
15 Seal
17, 18 Polarizing plate
20, 20B Backlight device
22 Light emitting diode (light source)
24 Backlight chassis
25 Reflector plate
26 Optical sheet
30 Bezel
32 Frame
41 Glass substrate
42 Pixel electrode
42a One of electrodes forming a storage capacitance
   43 Bus line
   44 Flattening layer
   46 Alignment film
   47 Thin film transistor
   47a Gate electrode
   47b Source electrode
   47c Drain electrode
   48 Scanning signal line
   51 Glass substrate
   52 Black matrix
   53 Color filter
   54 Flattening layer
   55 Counter electrode
   56 Alignment film
   61 The other of the electrodes forming a storage capacitance
   62 Storage capacitance line
   81 Gate driver
   81a, 82a Control signal
   82 Source driver
   90 Display image signal
   91 Maximum gray scale level detection circuit
   92 Gray scale conversion circuit
   100, 100A, 100B Liquid crystal display device
   122a-122d Light receiving sensor
   200 Control section
   201 Signal input section
   202 Timing controller
   202a Control signal sent from the timing controller
   203 Power source
   204 Backlight driving circuit
   220 Area active processing
   300 External system
   300a Control signal
   401 Input image
   402 LED control data
   403 LCD control data
   404 Output image
   A1-D1, A2-D2 Area
   a1-d1 Light receiving information
   a2-d2 Control signal
   Ccs Storage capacitance
   Clc Capacitor for manipulating the liquid crystal layer

1. A liquid crystal display device, comprising:
a liquid crystal display section including a plurality of pixels;
a backlight device for directing light from a plurality of light sources toward a rear surface of the liquid crystal display section;
light receiving sensors located at a plurality of sites along an edge portion of a front surface of the liquid crystal display section; and
a control section for dividing the liquid crystal display section into a plurality of areas, and controlling the liquid crystal display section and/or the backlight device based on light receiving information obtained from the light receiving sensors to perform control of adjusting a contrast of each of the areas independently.

2. The liquid crystal display device of claim 1, wherein the plurality of areas into which the liquid crystal display section is divided are preset by the control section in accordance with the plurality of sites at which the light receiving sensors are located.

3. The liquid crystal display device of claim 1, wherein the light sources for irradiating borders between the areas are controlled such that the contrast is gradually changed between the areas.

4. The liquid crystal display device of claim 1, wherein:
the liquid crystal display section includes a generally rectangular screen; and
the light receiving sensors are respectively located on four sides surrounding the generally rectangular screen.

5. The liquid crystal display device of claim 1, wherein:
the liquid crystal display section includes a generally rectangular screen; and
the light receiving sensors are respectively located at four corners of a peripheral edge portion of the screen.

6. The liquid crystal display device of claim 1, wherein the control section adjusts the contrast of each of the areas independently in accordance with a difference in the light receiving information sensed by the light receiving sensors.

7. The liquid crystal display device of claim 1, wherein the control section adjusts the contrast of the liquid crystal display section for each of the areas independently based on the light receiving information obtained from the light receiving sensors and in accordance with brightness of the sites at which the light receiving sensors are located, such that the contrast is strengthened at a bright site and is weakened at a dark site.

8. The liquid crystal display device of claim 1, wherein the control section includes a switching section for switching between a mode of performing control of adjusting the contrast of each of the areas independently and a mode of not performing the control.

9. The liquid crystal display device of claim 1, wherein in the case where certain light receiving information is obtained from the light receiving sensors for a predefined time duration, the control section performs control of adjusting the contrast of each of the areas independently.

10. The liquid crystal display device of claim 1, wherein the rear surface of the liquid crystal display section is divided into areas, different light guide plates are respectively located for the areas, and the light sources direct light toward the rear surface of the liquid crystal display section via the light guide plates.

11. The liquid crystal display device of claim 1, wherein the control section adjusts the contrast of each of the plurality of areas independently based on a video signal and the light receiving information obtained from the light receiving sensors.

12. The liquid crystal display device of claim 1, wherein the control section adjusts the contrast based on the light receiving information obtained from the light receiving sensors, such that the contrast is strengthened at a bright site of the liquid crystal display section and is weakened at a dark site.

13. The liquid crystal display device of claim 12, wherein a certain threshold value is provided for the light receiving information obtained from the light receiving sensors, and the brightness of the liquid crystal display section is determined based on the light receiving information obtained from the light receiving sensors.

14. The liquid crystal display device of claim 1, wherein:
the control section has a structure of controlling the liquid crystal display section and the backlight device based on input video information; and
a certain threshold value is provided for luminance information of the video information, and for a pixel having a luminance higher than the threshold value, the high luminance is multiplied by a predefined coefficient to increase the luminance, whereas for a pixel having a luminance lower than the threshold value, the low luminance is multiplied by the predefined coefficient to decrease the luminance.

15. The liquid crystal display device of claim 1, wherein the control section adjusts the brightness of the backlight device as the control of adjusting the contrast.

16. The liquid crystal display device of any claim 1, wherein the control section adjusts the brightness of each of the pixels of the liquid crystal display section as the control of adjusting the contrast.

17. The liquid crystal display device of any claim 1, further comprising:
a receiving section for receiving TV broadcast; and
a control section for controlling the liquid crystal display section and the backlight device such that an image based on the TV broadcast received by the receiving section is displayed.

18. The liquid crystal display device of claim 1, wherein the light sources are light emitting diodes.

19. A method for controlling a liquid crystal display device including a liquid crystal display section and a backlight device for directing light from a plurality of light sources toward a rear surface of the liquid crystal display section, the method comprising:
a first step of obtaining light receiving information from light receiving sensors located at a plurality of sites along an edge portion of a front surface of the liquid crystal display section; and
a second step of dividing the liquid crystal display section into a plurality of areas and controlling the plurality of light sources based on the light receiving information obtained in the first step to adjust a contrast of each of the areas independently.

20. The method for controlling a liquid crystal display device of claim 19, wherein in the second step, borders between the areas are controlled such that the contrast is gradually changed between the areas.

21. The method for controlling a liquid crystal display device of claim 19, wherein in the case where certain light receiving information obtained from the light receiving sensors in the first step is obtained for a predefined time duration, the second step is performed.
